(19) United States
(12) Patent Application Publication
(10) Pub. No.: US 2003/0157418 A1
(43) Pub. Date: Aug. 21, 2003

(54) Non-contact type non-magnetic monocomponent toner to develop electrostatic latent images and development unit using the same

(75) Inventors: Duck-hee Lee, Seoul (KR); Jong-moon Eun, Yongin-city (KR)

Correspondence Address: STAAS & HALSEY LLP, SUITE 700, 1201 NEW YORK AVENUE, N.W., WASHINGTON, DC, 20005, US

(73) Assignee: Samsung Electronics Co., Ltd., Suwon-city (KR)

(21) Appl. No.: 10/319,653

(22) Filed: Dec. 16, 2002

(30) Foreign Application Priority Data
Feb. 18, 2002 (KR) 2002-8562

(51) Int. Cl. G03G 9/08

(52) U.S. Cl. 430/108.3; 430/108.6; 430/108.7; 430/108.4; 430/108.8

(57) ABSTRACT

A non-contact type non-magnetic monocomponent toner to develop electrostatic latent images and a developing apparatus using the same. The toner includes toner particles containing a binding resin and coloring agents; and an external additive powder containing silicon oxide powder that has at least two kinds of particle sizes, separate inorganic compound powder, and zinc stearate. After passing a toner layer-regulating member, the toner evenly maintains a toner amount formed on a developing roller and forms a thin toner layer.

### CROSS-REFERENCE TO RELATED APPLICATIONS

This application claims the benefit of Korean Application No. 2002-8562, filed Feb. 18, 2002, in the Korean Intellectual Property Office, the disclosure of which is incorporated herein by reference.

### BACKGROUND OF THE INVENTION

1. Field of the Invention

The present invention relates to a non-contact type non-magnetic monocomponent toner to develop electrostatic latent images and a developing apparatus using the same. The toner and developing apparatus are used for output devices such as laser-type or LED printing head-type printers, facsimile machines, photocopiers, and multipurpose machines having an electrophotographic mode. More particularly, the present invention relates to a non-contact type non-magnetic monocomponent toner to develop electrostatic latent images and a developing apparatus using the same which are used for output devices which form images by transferring toner images onto a transfer-receiving material such as paper, after forming the developed images on an electrostatic latent image of a photosensitive member.

2. Description of the Related Art

In general, output devices such as laser printers and photocopiers electrically charge minute toner particles through friction by directly contacting the toner particles and a developing roller, and selectively attach the charged particles on an electrostatic latent image formed on a photosensitive drum made of a photoconductive material by an electrostatic force by using an electrical bias, thereby forming a toner image. The devices then transfer the toner image to a sheet of recording paper, and fix the toner image by heat and pressure, to thereby obtain a permanent image.

Developing agents used for such output devices are classified into a monocomponent developing agent composed of non-magnetic toner particles of a general synthetic resin material, and a dual component developing agent in which the non-magnetic toner particles are mixed with magnetic carrier particles in an appropriate mixture ratio.

The monocomponent developing agent is used in a still state in a developing device, which causes the problem of deteriorated fluidity of the developing agent when used for a long time. This increases the adhesive power between the toner particles and prevents the toner particles from being satisfactorily charged. In this case, even though a latent image is evenly formed, the visible image may be an ‘uneven image’ or a ‘dimmed image’. As a method of preventing this phenomenon, the toner is mixed in the developing device. However, excessive mixing of the toner may accelerate toner deterioration and shorten the life span of the developing agent.

In order to prevent the above problems, a method has been proposed which uses silicon oxide powder having a same polarity as the toner as a fluidity-improving agent. Although such a fluidity-improving agent improves developing performance due to the like polarity and improved fluidity, these improvements are insufficient to overcome the above problems.

For example, when using a fluidity-improving agent having particles of a very small diameter, it is difficult to form a thin toner layer with the increase of mass per unit area (M/A) for the toner layer formed on a developing roller after passing a regulating member of the toner layer. Accordingly, a fog phenomenon is likely to occur in the background portions of the image due to the adhesion of the toner, which will be scattered in a non-image portion in low-temperature and low-humidity environments (hereinafter, called “fog in the non-image area”). Further, since a small diameter particle leads to an increase in the surface area of the particles per unit mass, if the toner particles having the fluidity-improving agent are left for a long time in low-temperature and high-humidity environments, image density is likely to be lowered due to the wet toner particles.

If a fluidity-improving agent having large diameter particles is used, the M/A decreases, to facilitate the formation of a thin toner layer, improving the toner scattering, fog in the non-image area, and image density lowering problems. However, fluidity deteriorates.

The above problems are especially significant since a laser printer performs multiple functions, and thus the need for finer and higher-quality images is increased.

The resolution and quality of such images are mostly determined by a developing process transferring charged toner particles to a drum on which an electrostatic latent image is formed. That is, since the electrostatic latent image composed of ions selectively takes only toner particles having appropriate (opposite polarity) electric charges, in order to obtain a clear and high-quality image, the toner particles should have a uniform electric charge of a suitable magnitude. If the particles have a different polarity, or if excessively low or high electric charges exist, the phenomena such as fog in the non-image area, image concentration lowering, toner scattering, and so on occur, thereby deteriorating the image. Even though the quality of images is excellent at first, the concentration and quality of the images gradually deteriorate over time. Although such deterioration of the concentration and quality of images may occur due to the characteristics of the developing device, in most cases, the deterioration occurs due to the electrification characteristics of the toner particles. Thus, it is important for the toner particles to have a proper charge amount and a narrow charge distribution.

Further, insufficient toner charges produce a low transfer efficiency, cause low image density, make it difficult to suppress the toner image under an electric field, and disperse the toner image during transfer, all causing deterioration of image quality.

Another element affecting the quality of the final image is melting of the toner and the resulting fixing on the photosensitive drum. This occurs due to some of the main components of the toner, such as binding resin, wax, etc. If the toner fixes itself on the surface of the photosensitive drum, the photosensitive drum is not cleaned properly by the cleaning blades, and continues to accumulate, thereby making it difficult to form good quality images. Accordingly, there is an increased need for a new method of preventing the surface of the photosensitive drum from being polluted by toner fusion thereon.

### SUMMARY OF THE INVENTION

Accordingly, it is an aspect of the present invention to overcome the above problems of the conventional contact-type developing mode, by employing a non-contact type developer to enhance resolution, and reduce the occurrence of fog in the non-image area and non-uniform developer concentration.

It is another aspect of the present invention to overcome the increased occurrence of fog in the non-image area and non-uniform developer concentration caused by use over time.

It is still another aspect of the present invention to improve image quality by reducing scattering of toner after passing a toner layer-regulating member such as a charging blade, and to form a thin toner layer, without loss in fluidity over time.

It is still another aspect of the present invention to prevent developing deterioration occurring due to the increase in toner stress.

It is yet another aspect of the present invention to improve charging stability of the toner.

It is still another aspect of the present invention to prevent the melting of the toner and the resulting fixing on the photosensitive drum and the toner layer-regulating member.

Additional aspects and advantages of the invention will be set forth in part in the description which follows and, in part, will be obvious from the description, or may be learned by practice of the invention.

The foregoing and other aspects are achieved by providing a non-contact type nonmagnetic monocomponent toner, including a plurality of toner particles including a binding resin and a coloring agent; and an external additive powder, wherein an acid value of the binding resin is below 12 mgKOH/g, and the external additive powder includes a silicon oxide powder including particles of first and second sizes, an inorganic compound powder, and zinc stearate.

According to an aspect of the present invention, an acid value of the binding resin is below 12 mgKOH/g in order to prevent toner fusion onto the photosensitive drum and the toner layer-regulating member when used for a long time.

The silicon oxide powder may include a concentration of 0.1-3.0% (by weight) of the first particle size, having a diameter of 20-200 nm; and a concentration of 0.1-3.0% (by weight) of the second particle size, having a diameter less than 40 nm, to improve fluidity.

Since fog in the non-image area and a mass per unit area (M/A) of the toner layer formed on the developing roller after passing the toner layer-regulating member increase as the content of the small-diameter silicon oxide is larger than the content of the large-diameter silicon oxide, in order to form the toner layer in a thin layer to prevent the fog in the non-image area and scattering, the added amount of the large-diameter silicon oxide may be more than that of the small-diameter silicon oxide. In general, when the added amount of the large-diameter silicon oxide is 1.5 times more than that of the small-diameter silicon oxide, the fog in the non-image area and scattering problems can be suppressed.

The inorganic compound powder may include a concentration of 0.1-2.0% (by weight) of at least one compound selected from the group consisting of BaTiO₃, SrTiO₃, CaTiO₃, PbTiO₃, TiO₂, SnO₂, CaO, MgO, Al₂O₃, Fe₂O₃, gamma Fe₂O₃, MgSiO₃, Fe₃O₄, ZrO₂, B₂O₃, SiC, Si₃N₄, NiFe₂O₄, ZnFe₂O₄, Ni—ZnFe₂O₄, and BaFe₂O₄.

A concentration of the zinc stearate may be 0.01-0.5% by weight with particle diameters in the range of 0.1 to 10 μm to improve durability. If the concentration of the zinc stearate is below 0.01% by weight or more than 0.5% by weight, the fog in the non-image area increases, and the charge amount per unit mass (Q/M) of the toner layer formed on the developing roller after passing the toner layer-regulating member abruptly decreases.

The toner particles may be formed by a pulverizing method to pulverize a polymerized monomer compound containing at least a polymerized monomer and coloring agents. Selectively, the toner particles are formed by a polymerization method polymerizing a polymerized monomer compound in an aqueous medium in the presence of a polymerization initiator, etc. The polymerized monomer compound contains at least a polymerized monomer and coloring agents.

The toner may be nonmagnetic, and used for a monocomponent developing agent.

The foregoing and other objects of the present invention are also achieved by providing a developing apparatus detachably mounted in a main body of an image-forming apparatus, the developing apparatus including a non-contact type non-magnetic monocomponent developing agent, including a plurality of toner particles including a binding resin and a coloring agent, and an external additive powder; a developing container to accommodate the non-contact type non-magnetic monocomponent developing agent, a photosensitive surface having a developing area; and a developing roller to receive and transfer onto the developing area the non-contact type non-magnetic monocomponent developing agent accommodated in the developing container; and a toner layer regulating member to regulate a thickness of a layer of the developing agent received by the developing roller; wherein the external additive powder includes a silicon oxide powder including particles of first and second sizes, an inorganic compound powder, and zinc stearate, and a mass per unit area (M/A) of the layer of the developing agent received by the developing roller after passing the toner layer-regulating member is between 0.4-0.9 mg/cm².

According to an aspect of the present invention, a charge amount per unit mass (Q/M) of the layer of the developing agent received by the developing roller after passing the toner layer-regulating member is −5 to −30 μC/g.

### BRIEF DESCRIPTION OF THE DRAWINGS

These and other objects and advantages of the invention will become apparent and more readily appreciated from the following description of the preferred embodiments, taken in conjunction with the accompanying drawings of which:

FIG. 1 is a cross-sectional view of a developing unit using a non-contact type nonmagnetic monocomponent toner for developing electrostatic latent images according to an embodiment of the present invention.

### DETAILED DESCRIPTION OF THE PREFERRED EMBODIMENTS

Reference will now be made in detail to the present preferred embodiments of the present invention, examples of which are illustrated in the accompanying drawings, wherein like reference numerals refer to like elements throughout.

In general, the diameter distribution among all of the toner and the charging characteristics thereof greatly affects the image characteristics, and such charging characteristics of the toner differ between surface-constructing materials of the toner, so that images are greatly affected by the materials externally added to the surfaces of the toner particles. For this reason, the present invention controls the characteristics of the toner particle surfaces by changing the types of external additives, diameters, and the external additive amounts in order to obtain improved image quality and reduction in fog in the non-image area and scattering.

The toner of the present invention includes toner particles composed of binding resin, a charge-controlling agent, release agents and coloring agents, and silicon oxide powder, inorganic compound powder, and zinc stearate externally added to the surfaces of the toner particles.

The binding resin is composed of a compound of one or more of styrene, such as polystyrene and polyvinyl toluene, monopolymer of a styrene derivative, styrene copolymer such as styrene-acryl copolymer, polyethylene, polypropylene, vinyl chloride-based resin, polyarcrylate, polymethacrylate, polyester, polyacrylonitrile, melamine resin, and epoxy resin.

The acid number of the binding resin may be below 12 mgKOH/g in order to prevent toner fusion to a photosensitive drum and a toner layer-regulating member, such as charging blade, when used over a long period of time.

The charge-controlling agent to stabilize the chargeability of the toner may be 0.1 to 10% (by weight), more specifically 0.2 to 5% (by weight) per binding resin 100% (by weight).

The charge-controlling agent may generally include the following substances. A negative charge-controlling agent to provide a negatively chargeable toner may include organic metal dyes such as chromium-containing azo dyes or mono azo metal dyes, or chelate compound; salicylic acid compound containing metals such as chromium, iron, and zinc; and organic metal dyes of aromatic hydroxy-carboxylic acid and aromatic decarboxylic acid.

A positive charge-controlling agent to provide a positively chargeable toner may be one of or a mixture of two or more onium salts and the like including a quaternary ammonium salt such as tributylbenzilammonium 1-hydroxy-4-naphthosulfonate, tetrabutylammonium tetrafluoroborate, and so on, and nigrosine and products quality-improved with fatty acid metal salt and the like.

The coloring agent may be a non-magnetic coloring agent such as pigments, dyes, or the like.

The pigment may be carbon black, aniline black, naphthol yellow, hansa yellow, rhodamine lake, alizarine lake, red iron oxide, phthalocyanine blue, and indanthrene blue. The pigment may be used with a concentration of 0.1 to 20% (by weight), in particular, the concentration may be 1 to 10% (by weight), per binding resin 100% (by weight).

In the embodiment of the present invention, if necessary, one or more types of offset-preventive agents or release agents may be added to the toner particles.

The release agents may be aliphatic hydrocarbon wax such as low-molecular weight polyethylene wax, low-molecular weight polypropylene wax, microcrystalline wax, paraffin wax, and the like, oxidized products of aliphatic hydrocarbon wax such as polyethylene oxide wax and the like, and block copolymer thereof; wax having, as a main component, aliphatic ester such as carnauba wax, sasol wax, montanic acid ester wax and the like, and partial or completely deoxidized aliphatic ester of deoxidized carnauba wax and the like.

The release agent may be used in a concentration of 0.1 to 20% (by weight), in particular, the concentration may be 0.5 to 10% (by weight) per binding resin 100% (by weight).

The release agent may be evenly dispersed in the binding resin by mixing the release agent in a resin solution during agitating and heating, or by fusing the binding resin together with a release agent.

The external additives are used to increase powder fluidity and developing performance, and greatly improve the charging characteristics of the toner particles to play a role of second charge-controlling agents.

Silicon oxide is mainly used as the external additive. For improvement in durability and transferability, large-diameter silicon oxide particles (ranging from 20 to 200 nm in diameter) are added in a concentration of 0.1-3.0% (by weight), and, for fluidity improvement, small-diameter silicon oxide particles (less than 40 nm in diameter) are added in a concentration of 0.1-3.0% (by weight).

Since the fog in the non-image area and the mass per unit area (M/A) of a toner layer formed on the developing roller after passing the toner layer-regulating member increase as the percentage by weight of the small-diameter silicon oxide particles is larger than the percentage by weight of the large-diameter silicon oxide particles, in order to form the toner layer on the developing roller in a thin layer to suppress the fog in the non-image area and scattering problems, more of the large-diameter silicon oxide particles may be added as compared to the small-diameter silicon oxide particles. In general, when the added amount of the large-diameter silicon oxide particles is 1.5 times more than that of the small-diameter silicon oxide particles, the M/A is maintained in a range from 0.4 to 0.9 mg/cm², and more specifically, in a range from 0.6 to 0.9 mg/cm², which is appropriate to form a thin layer, enabling the suppression of the fog in the non-image area and scattering problems.

However, if the M/A is maintained below 0.9 mg/cm², an excessive stress is exerted on the toner so that a problem occurs which adversely affects toner longevity. For example, the external additives may be separated from the surface of the toner.

Therefore, in order to ensure the longevity of the toner even though the M/A is maintained below 0.9 mg/cm², zinc stearate is added, as a lubricant, in the non-contact type non-magnetic monocomponent toner of the embodiment of the present invention.

In detail, the zinc stearate includes a compound expressed in a chemical formula as below. That is,

C₃₆H₇₀O₄Zn (1)

The zinc stearate enhances the developing efficiency with the minimization of the Van der Waals and electrostatic forces of the toner, and of preventing the separation of the external additives on the toner surface due to extended use. The zinc stearate may range in size from 0.1 to 10 μm, and is added in a concentration of 0.01 to 0.5% (by weight). If the concentration of the zinc stearate is less than 0.01% (by weight), the effects of the addition of the zinc stearate are not realized, and, if more than 0.5% (by weight), the fog in the non-image area increases and the charge amount per unit mass (Q/M) of the toner layer abruptly decreases outside of a range of −5 to −30 μC/g.

Inorganic compound powder, as an external additive may be used to obtain charging stability and to prevent the photosensitive drum and the images from being polluted by the fusion of the toner.

Substances used for the inorganic compound powder additive may be a compound of one or more of BaTiO₃, SrTiO₃, CaTiO₃, PbTiO₃, TiO₂, SnO₂, CaO, MgO, Al₂O₃, Fe₂O₃, gamma Fe₂O₃, MgSiO₃, Fe₃O₄, ZrO₂, B₂O₃, SiC, Si₃N₄, NiFe₂O₄, ZnFe₂O₄, Ni—ZnFe₂O₄, and BaFe₂O₄. In particular, TiO₂ or Al₂O₃ may be used. A diameter of 60 nm to 3 μm may be used.

When externally adding substances having diameters within this range, the fusion of the toner particles is remarkably reduced. If the diameter is less than 60 nm, excessive fog in the non-image area may occur, and, if the diameter is greater than 3 μm, fusion of the toner on the photosensitive drum may occur and the resulting excessive wear and tear will shorten the lifespan of the photosensitive drum.

Further, the characteristics of the surface of the toner vary according to the amount of the inorganic compound powder externally added. The amount of the added inorganic compound powder may be 0.1 to 2.0% (by weight).

The non-contact type non-magnetic monocomponent toner constructed as above may be manufactured through a process of powder mixing, melting and roll mixing milling, coarse grinding, fine grinding, classification, and external additives addition. The toner may be formed by a polymerization method polymerizing polymerized monomer composition in an aqueous medium under the existence of a polymerization initiator, the polymerized monomer composition including at least a polymerized monomer and a coloring agent.

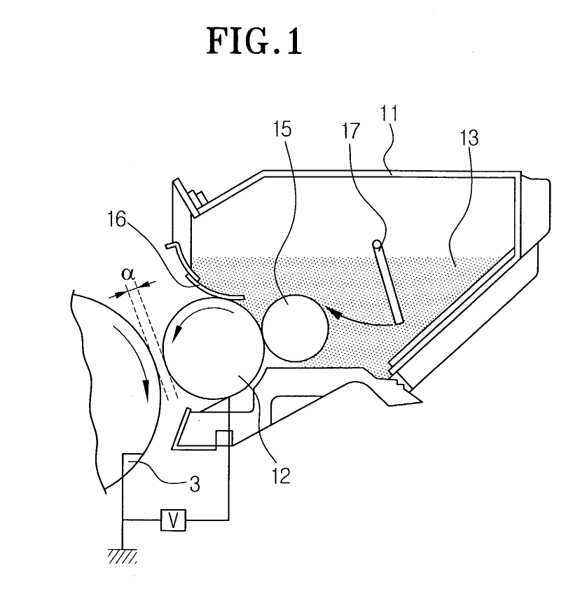

In FIG. 1, a non-contact type developing unit of an image-forming apparatus is shown which uses the toner for developing electrostatic latent images according to the embodiment of the present invention as a developing agent.

The non-contact type developing unit has a developing container 11 to accommodate toner 13 as a developing agent of the type described above. A developing roller 12 to carry the toner 13 is accommodated in the developing container 11 to attach the toner 13 to a developing area of a photosensitive drum 3. The developing unit also includes a supply roller 15 to supply the toner 13 onto the developing roller 12, an elastic blade 16, as a toner layer thickness regulating member, to regulate a toner layer thickness on the developing roller 12, and a mixing member 17 to mix the toner 13 in the developing container 11.

The photosensitive drum 3 forms an electrostatic latent image due to a laser beam emitted from a laser scanning unit (not shown). The developing roller 12 includes a nickel-coated aluminum cylinder body having a surface illumination level from 1 to 2.5 Rz, or anywhere less than 5.0 Rz, or a rubber roller having a resistance less than 5×10⁶ Ω and a hardness less than 80.

The toner 13 is stored in the developing container 11, and is supplied onto the developing roller 12 by the supply roller 15. The supply roller 15 is formed of a foam such as a polyurethane foam, rotating in forward or reverse directions with respect to the developing roller 12 and to supply the toner 13 onto the developing roller 12.

The toner 13 supplied onto the developing roller 12 is evenly coated in a thin layer by the elastic blade 16 used as a toner layer thickness regulating member.

In order for the elastic blade 16 to contact the developing roller 12, a pressure applied to the developing roller 12 may be 0.5 to 12 kg/m, or anywhere in the range of 0.3 to 25 kg/m of linear pressure. This pressure effectively allows the coagulation of the toner 13 to be loose and a charge amount of a non-magnetic monocomponent developing agent to increase simultaneously.

The elastic blade 16 is formed of an elastic rubber body such as silicon rubber, urethane rubber, and acrylonitrile-butadiene-styrenerubbers (NBR), elastomer such as polyethlene terephthalate and polyamide; elastic metal body such as stainless steel, steel, and phosphorylated bronze, or a compound thereof.

The thickness of the toner layer formed on the developing roller 12 is smaller than a gap a between the surfaces of the developing roller 12 and the photosensitive drum 3, and a certain voltage may be applied to the gap a. This allows the toner to easily move from the surface of the developing roller 12 to the surface of the photosensitive drum 3, to thereby obtain images of good quality.

The gap α between the developing roller 12 and the photosensitive drum 3 may be 100-400 μm, or anywhere in the range of 50-500 μm. The mass per unit area (M/A) of the toner layer formed on the developing roller 12 may be 0.6 to 0.9 mg/cm², or anywhere in the range of 0.4-0.9 mg/cm². A charge amount per unit mass (Q/M) of the toner layer may be −5 to −20 μC/g, or anywhere in the range of −5 to −30 μC/g.

A voltage applied to the developing roller 12 is 1.8 kV, or an another value greater than 0.1 kV of a peak-to-peak voltage (Vp-p). A bias may be applied having a frequency of 2.0 kHz, or anywhere in the range of 1.0 to 3.0 kHz. A waveform shape of the bias may be a rectangular wave having a duty ratio between 20 and 40%, or anywhere less than 50%, preferably 20 to 40%.

As an example, the embodiment of the present invention may be formed as follows.

After mixing styrene acrylic copolymer 86% (by weight) a binding resin, chromium-containing azo dye 2% (by weight) as a negative charge-controlling agent, polyethelene wax 2% (by weight) as the release agent, and carbon black 10% (by weight) as the coloring agent, through melting and roll-mixing-milling by a one-axis continuity-type mixing mill, an internal additive-contained toner of a plate form is obtained. Through cooling, grinding, and classifying the toner, a non-external additive contained toner is obtained.

Large-diameter silicon oxide powder 1.0% (by weight), small-diameter silicon oxide powder 0.5% (by weight), TiO₂ 1.0% (by weight), and zinc stearate 0.05% (by weight) were added into and mixed with the non-external additive contained toner 100% (by weight), to thereby obtain a noncontact-type nonmagnetic monocomponent toner to be provided for tests.

Printed images have been made with the toner obtained as above under the following conditions in the non-contact type developing unit shown in FIG. 1.

Surface voltage(V_{O}) of the photosensitive drum 3: −700V

latent image voltage(V_{L}) of the photosensitive drum: −100V

voltage applied to the developing roller: Vp-p=1.8 KV, frequency=2.0 KHz, Vdc=250V

developing gap α=250 μm

developing roller: nickel-coated aluminum roller having 1-5 Rz, or a rubber roller of a resistance of 5×10⁵ Ω and hardness of 50.

As a result, even after continuously printing more than 10,000 sheets, as shown below, it was observed that an even toner layer was maintained on the developing roller and a stable charge amount was maintained.

For the toner layer formed after passing the development-regulating member,

Q/M: −5˜−30 μpC/g

M/A: 0.4˜0.9 mg/cm²

Further, stable and excellent images with no fog in the non-image area and solid pattern concentrations of more than 1.3 could be obtained.

As mentioned above, the non-contact type non-magnetic monocomponent toner to develop electrostatic latent images and a developing apparatus using the same according to the embodiment of the present invention allow a toner amount formed on the developing roller 12 to be evenly maintained as well as a toner layer to be formed in a thin layer after passing a toner layer-regulating member (the elastic blade 16) without producing a fluidity problem over a long time. Thus, image quality improves by reducing fog in the non-image area, scattering, and the like.

Further, the toner 13 and developing apparatus of the embodiment of the present invention prevent fusing of the toner on the photosensitive drum 3 and the toner layer-regulating member 16, to thereby achieve high-quality images even after a long period of use.

Further, the toner and developing apparatus of the present invention can prevent the developing deterioration occurring due to forming of a toner layer in a thin layer as well as the durability deterioration due to toner stress increases.

Furthermore, the toner and developing apparatus provides improved charging stability.

Although a few preferred embodiments of the present invention have been shown and described, it will be appreciated by those skilled in the art that changes may be made in these embodiments without departing from the principles and spirit of the invention, the scope of which is defined in the claims and their equivalents.

What is claimed is:

1. A non-contact and non-magnetic monocomponent toner, comprising:
a plurality of toner particles comprising at least a binding resin and a coloring agent; and
an external additive powder, wherein:
an acid value of the binding resin is below 12 mgKOH/g, and
the external additive powder comprises:
a silicon oxide powder including particles of first and second sizes,
an inorganic compound powder, and
zinc stearate.

2. The toner as claimed in claim 1, wherein the silicon oxide powder comprises:
a concentration of 0.1-3.0% (by weight) of the particles of the first size, having a diameter of 20-200 nm; and
a concentration of 0.1-3.0% (by weight) of the particles of the second size, having a diameter less than 40 nm.

3. The toner as claimed in claim 2, wherein the concentration of the particles of the first size greater than the concentration of the particles of the second size.

4. The toner as claimed in claim 3, wherein the concentration of the particles of the first particle size is 1.5 times greater than the concentration of the particles of the second particle size.

5. The toner as claimed in claim 2, wherein the inorganic compound powder comprises a concentration of 0.1-2.0% (by weight) of at least one compound selected from the group consisting of BaTiO₃, SrTiO₃, CaTiO₃, PbTiO₃, TiO₂, SnO₂, CaO, MgO, Al₂O₃, Fe₂O₃, gamma Fe₂O₃, MgSiO₃, Fe₃O₄, ZrO₂, B₂O₃, SiC, Si₃N₄, NiFe₂O₄, ZnFe₂O₄, Ni—ZnFe₂O₄, and BaFe₂O₄.

6. The toner as claimed in claim 1, wherein a concentration of the zinc stearate is 0.01-0.5% (by weight).

7. The toner as claimed in claim 6, wherein the zinc stearate is comprised of particles having a diameter of 0.1-10 μm.

8. The toner as claimed in claim 5, wherein a concentration of the zinc stearate is 0.01-0.5% (by weight).

9. The toner as claimed in claim 8, wherein the zinc stearate is comprised of particles having a diameter of 0.1-10 μm.

10. The toner as claimed in claim 9, wherein the toner particles are formed by a polymerization method polymerizing a polymerized monomer compound in an aqueous medium under the existence of a polymerization initiator, the polymerized monomer compound including at least a polymerized monomer and the coloring agent.

11. The toner as claimed in claim 9, wherein the toner particles are formed by a pulverizing method to pulverize a polymerized monomer compound including at least polymerized monomer and the coloring agent.

12. A developing apparatus detachably mounted in a main body of an image-forming apparatus, the developing apparatus comprising:
a non-contact and non-magnetic monocomponent developing agent, comprising:
a plurality of toner particles including at least a binding resin and a coloring agent, and
an external additive powder;
a developing container to accommodate the non-contact and non-magnetic monocomponent developing agent;
a photosensitive surface having a developing area;
a developing roller to receive and transfer onto the developing area the non-contact and non-magnetic monocomponent developing agent accommodated in the developing container; and
a toner layer regulating member to regulate a thickness of a layer of the developing agent received by the developing roller,
wherein the external additive powder comprises:
a silicon oxide powder including particles of first and second sizes,
an inorganic compound powder, and
zinc stearate, and
a mass per unit area (M/A) of the layer of the developing agent received by the developing roller after regulated by the toner layer regulating member is between 0.4-0.9 mg/cm².

13. The developing apparatus as claimed in claim 12, wherein a charge amount per unit mass (Q/M) of the layer of the developing agent received by the developing roller regulated by the toner layer regulating member is −5 to −30 μC/g.

14. A compound, comprising:
a plurality of toner particles; and
a powder, comprising:
a silicon oxide powder including a plurality of particles of first and second sizes,
an inorganic compound powder, and
zinc stearate.

15. The compound as claimed in claim 14, wherein the compound is a non-contact type non-magnetic monocomponent developing agent.

16. The compound as claimed in claim 15, wherein the toner particles comprise:
a binding resin;
a charge controlling agent to stabilize a chargeability of the compound;
a release agent; and
a coloring agent.

17. The compound as claimed in claim 16, wherein the binding resin comprises polystyrene, polyvinyl toluene, monopolymer of a styrene derivative, styrene copolymer, polyethylene, polypropylene, vinyl chloride-based resin, polyarcrylate, polymethacrylate, polyester, polyacrylonitrile, melamine resin, or epoxy resin.

18. The compound as claimed in claim 17, wherein an acid value of the binding resin is below 12 mgKOH/g.

19. The compound as claimed in claim 18, wherein a concentration of the charge controlling agent is 0.1 to 10% (by weight).

20. The compound as claimed in claim 19, wherein the charge controlling agent comprises a negative charge controlling agent to negatively charge the compound and comprising:
an organic metal dye or a chelate compound;
a salicylic acid compound;
an organic metal dye including an aromatic hydroxy-carboxylic acid and an aromatic decarboxylic acid.

21. The compound as claimed in claim 19, wherein the charge controlling agent comprises a positive charge controlling agent to positively charge the compound and comprising:
a mixture of two or more onium salts; and
nigrosine.

22. The compound as claimed in claim 16, wherein the coloring agent is a nonmagnetic coloring agent.

23. The compound as claimed in claim 22, wherein the coloring agent is a pigment having a concentration of 1 to 10% (by weight), per binding resin 100% (by weight).

24. The compound as claimed in claim 14, further comprising a release agent added to the toner particles.

25. The compound as claimed in claim 24, wherein the release agents is aliphatic hydrocarbon wax, low-molecular weight polypropylene wax, microcrystalline wax, paraffin wax, oxidized products of aliphatic hydrocarbon wax, carnauba wax, sasol wax, montanic acid ester wax, or partially or completely deoxidized aliphatic ester of deoxidized carnauba wax.

26. The compound as claimed in claim 25, wherein the release agent has a concentration of 0.1 to 20% (by weight) per binding resin 100% (by weight).
